(19) United States
(12) Patent Application Publication
(10) Pub. No.: US 2016/0315367 A1
(43) Pub. Date: Oct. 27, 2016

(54) Rechargeable Battery with Aluminium Anode and a Supercapacitor as Cathode

(71) Applicant: Pedro Brito Correia, Estoril (PT)

(72) Inventor: Pedro Brito Correia, Estoril (PT)

(21) Appl. No.: 14/693,989

(22) Filed: Apr. 23, 2015

(51) Int. Cl. H01M 12/00; H01G 11/70

(52) U.S. Cl. CPC H01M 12/005; H01G 11/70

(57) ABSTRACT

A new battery is claimed where in the loaded state one electrode is aluminium metal and the second electrode is a supercapacitor with a double layer of aluminium ions with 3 positive charges separated by a dielectric layer from iodine ion with one negative charge.

In the unloaded state the new battery has one electrode made of aluminium metal and a second electrode is the supercapacitor consisting in neutral iodine contained in a dielectric layer.

In this way the new battery presents an enthalpy difference between the aluminium ions and the aluminium metal which is the ionization energy of 5139 kJ/mole, corresponding to 53.27 Volt.

Earlier batteries present an enthalpy difference between aluminium metal and aluminium chloride of 704.2 kJ/mole (Gibbs Energy 628.8 kJ/mole), which corresponds to 6.52 Volt.

### FIELD OF INVENTION

Rechargeable batteries with aluminium anode, supercapacitors, electricity storage for renewable energy production

### BACKGROUND OF THE INVENTION

The interest of electrical energy storage is well known, concerning portable telephones, computers, tablets, cars and grid transporting electricity.

Batteries have to fulfil many objectives: quantity of energy stored, weight, number of load cycles, cost of production, safety.

Traditional batteries are based on two different chemical reactions taking place each one on the surface of one electrode in the presence of an electrolyte.

The Gibbs Energy difference between the reaction in each electrode determines the maximum voltage which can be obtained.

The redox potential is defined as the difference between the ionization potential of a gaseous metal atom and the solvation potential of that atom in the electrolyte. This solvation may include ionic bonds.

In the case of aluminium, both the ionization potential and the solvation in the electrolyte are very high, therefore their difference is small, and the redox potential is defined as this difference.

In order to obtain the full advantage of the high ionization energy and corresponding potential of aluminium to 3 positive charges, it is necessary to avoid the solvation.

To ionize aluminium it is necessary to supply 577.5 kJoule/mole for the first electron, 1816.7 kJoule/mole for the second electron and 2744.8 kJoule/mole for the third electron. The energy necessary for full ionization is therefore 5139.0 kJoule/mole. This value corresponds to a tension of 53.27 Volt. In earlier aluminium batteries (ref. 1, 2, 3, 5), the reaction converts aluminium metal into aluminium III chloride, the enthalpy difference between initial and final state is 704.2 kJoule /mole, while the Gibbs energy is 628.8 kJ/mole. This Gibbs energy corresponds to 6.52 Volt. In fact, aluminium rechargeable batteries are described which generate a tension inferior to 2.5 Volt.

Our idea was to take advantage of the full ionization energy and corresponding tension of aluminium. We tried a plasma battery (ref 4), where we ionised the aluminium vapour in a plasma. However, the energy consumption for the production of the plasma state is too high and local plasma tension fluctuates strongly.

We searched for a process at room temperature to take advantage of the full ionization energy of aluminium in a rechargeable battery.

### DETAILED DESCRIPTION OF THE INVENTION

A new battery is claimed where in the loaded state one electrode is aluminium metal and the second electrode is a supercapacitor constituted by a double layer of aluminium ions with 3 positive charges separated by a dielectric layer from iodine or bromine ions with one negative charge, graphene or a polymeric conductor (ref. 6, 7).

In the unloaded state the new battery has one electrode made of aluminium metal and a second electrode consisting of neutral iodine or bromine contained in a vessel with a dielectric wall.

In this way, the new battery presents an enthalpy difference between the aluminium ions and the aluminium metal which is the ionization energy of 5139 kJ/mole, corresponding to 53.27 Volt.

Earlier batteries present an enthalpy difference between aluminium metal and aluminium chloride of 704.2 kJ/mole (Gibbs Energy 628.8 kJ/mole), which corresponds to 6.52 Volt.

Our invention creates a battery with a high storage capacity of electrical energy, because it eliminates the need of chemical reactions taking place in one electrode, which is substituted by a capacitor. Therefore, the redox potential corresponds to the high ionization energy of aluminium.

### EXAMPLE

We used a glass ampoule with 20 mm diameter and 200 mm height, with a round bottom and a flanged top. The top contains
a pipe with a valve to eliminate the air with a vacuum pump.
A hole for introducing an aluminium rod with 2 mm diameter and 250 mm length. One end of this rod goes to the bottom of the ampoule and another end stays 20-30 mm outside of the ampoule
A stainless steel wire with one mm diameter connects the capacitor in the interior of the ampoule with a power generator of continuous voltage, which is connected to the aluminium electrode.

The supercapacitor (ref 7) is constituted by a glass pipe with rough surface to increase the specific contact surface.

This glass pipe has a round bottom, and presents 5 mm interior diameter, 7 mm exterior diameter.

In the glass pipe is iodine in a 100 mm height, which was previously molten to fill the pipe. The iodine is connected to the stainless steel wire in a length of 50 mm.

The space between the aluminium electrode and the supercapacitor was filled with a mixture of N-Methyl Imidazole (NMI) and bis (trifluormethanesulfonyl) imide (Imide) in a proportion of 0.1 mole of imide to 1.0 mole of NMI.

After eliminating the air at a pressure below 0.1 milibar, we applied to the electrodes a continuous tension of 60 Volt so that electrons were pumped from the aluminium electrode to the supercapacitor. After 30 minutes we stopped the loading process and measured the tension between the electrodes, which was 42.2-43.5 Volt.

The energy which we recovered from the battery was 90% of the energy we spend to load the battery.

This process was repeated 100 cycles, with no significant differences.

1. A rechargeable battery with aluminium anode, a supercapacitor containing iodine closed in a vessel with a wall made of a non conductive dielectric material as cathode and an electrolyte containing an ionic liquid N-Methyl Imidazolium salt from a weak acid.

2. In the product of claim 1 where the purity of the aluminium anode may be 99.5 to 99.9999

3. In the product of claim 1 where the aluminium anode can be doped to improve its properties with small quantities of metals or metalloids, which may be but are not limited to selen, zinc, beryllium.

4. In the product of claim 1 where the form of the electrodes and the geometry of the electrolyte space can be adapted to the needs of the application and may therefore contain electrodes as rods, sheets, plane or cylindrical and the distances between electrodes may vary from 0.1 to 10 mm.

5. In the product of claim 1 where the ionic liquid is an N-Methyl imidazolium salt of a weak acid namely acetic, trifluor borate, bis (trifluor methanesulfonyl) imide and part of the N-Methyl imidazole is in excess to the amount of the anion from the referred weak acid.

6. In the product of claim 1 where the supercapacitor consists in a vessel made of a non conductive material with a dielectric constant chosen to avoid electric discharge between the positive and negative sides of the electrical double layer, and its surface is prepared to achieve a high ratio surface to volume of the dielectric, which corresponds to silicates or alumino silicates.

7. In the product of claim 1 where the interior space of the dielectric vessel of the supercapacitor, as described in claim 6, contains iodine, bromine, graphene or a polymeric conductor.
